(19) United States
(12) Patent Application Publication
(10) Pub. No.: US 2005/0083986 A1
(43) Pub. Date: Apr. 21, 2005

(54) Light-emitting diode pumped laser and method of excitation

(75) Inventor: Francisco J. Duarte, Rochester, NY (US)

Correspondence Address: Thomas H. Close;Patent Legal Staff, Eastman Kodak Company, 343 State Street, Rochester, NY, 14650-2201, US

(73) Assignee: Eastman Kodak Company

(21) Appl. No.: 10/687,998

(22) Filed: Oct. 17, 2003

(51) Int. Cl. H01S 3/091

(52) U.S. Cl. 372/70

(57) ABSTRACT

A light-emitting diode pumped laser and method of excitation. The laser apparatus emits a beam of coherent light directed along an optical axis, and includes a first and second optical element; at least one light-emitting diode; a gain medium; and a guiding member. The light-emitting diode produces a beam of light directed along an optical excitation path transverse to the optical axis of the laser apparatus. The gain medium is disposed in the optical axis and the optical excitation path, intermediate the first and second optical elements, for producing the beam of coherent light along the optical axis. The guiding member directs the beam of light produced by the light-emitting diode toward the gain medium.

### FIELD OF THE INVENTION

The invention relates generally to the field of lasers. More specifically, the invention relates to a laser apparatus including a light-emitting diode.

### BACKGROUND OF THE INVENTION

The conversion of incoherent light into coherent light/radiation is known to those skilled in the art. For example, such conversion has been demonstrated in flashlamp-pumped solid-state dye lasers. In these lasers, an incoherent source of photon energy is used to excite, or to “pump”, a laser gain material/medium/media within an optical resonator to elevated excitation levels.

U.S. Pat. No. 5,181,222 (Duarte), commonly assigned and incorporated herein by reference, shows a tunable dye laser using a dispersive resonator and a liquid gain media/medium to “tune” the laser to emit light at different wavelengths. FIG. 1 shows a schematic diagram of a dye laser apparatus 20 disclosed in U.S. Pat. No. 5,181,222. As illustrated, apparatus 20 includes a narrow linewidth laser output beam indicated at 22 by parallel dashed lines. The diameter of beam 22 is indicated at W. A gain medium or dye cell 24 is “pumped” or excited by a beam 26 from a source such as a copper laser. Forming part of an optical cavity of the laser apparatus 20 is a first prism 30 which receives laser emission from dye cell 24 at an incident angle indicated at φ1,1. Laser light (indicated by the shaded area) from prism 30 is directed at an angle φ1,2 onto a second prism 32 and thence is refracted at an angle ψ1,2 in an expanded beam (shaded area) onto a Littrow-mounted grating 34. The angle of light incident on and diffracted from grating 34 is indicated by an angle θ. The relationships of these angles to the laser beams within the multiple-prism Littrow (MPL) mounted grating portions of the optical cavity are given in detail in a book entitled DYE LASER PRINCIPLES by Duarte, an inventor of the present invention, and is incorporated herein by reference. After being diffracted back from Littrow-mounted grating 34, through prism 32 and prism 30, the laser light is highly polarized and frequency narrowed. The plane of polarization here lies parallel to the plane of FIG. 1. This polarized light passes back through dye cell 24 for further amplification and becomes a narrow linewidth laser beam 38 having the diameter W. As the polarized beam 38 continues to the left from dye cell 24, it encounters a specially provided, partially reflecting polarizer device 40. The outer or left-most face of polarizer device 40 is made partially reflecting by a suitable coating 42, such as a very thin layer of low-loss dielectric material, which provides reflection of a portion of laser beam 38. The remaining portion of beam 38 passes through reflecting coating 42 and becomes laser output beam 22. Laser beam 22 is polarized in a plane parallel to the plane of FIG. 1.

While such lasers have achieved certain degrees of success in their particular applications, there is a need for an apparatus and method for exciting the laser which is robust, reliable, and inexpensive. In addition, the operation of such a laser apparatus can be readily programmable and provides a more compact laser apparatus.

### SUMMARY OF THE INVENTION

An object of the present invention is to provide an apparatus and method for exciting a laser apparatus.

Another object of the present invention is to provide such a apparatus/method to excite a gain medium comprising the laser apparatus.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a laser apparatus for emitting a beam of coherent light directed along an optical axis. The laser apparatus includes a first and second optical element; at least one light-emitting diode producing a beam of light directed along an optical excitation path transverse to the optical axis of the laser apparatus; a gain medium disposed in the optical axis and the optical excitation path, intermediate the first and second optical elements, for producing the beam of coherent light along the optical axis; and a guiding member for directing the beam of light produced by the at least one light-emitting diode toward the gain medium.

According to another aspect of the invention, there is provided a method for emitting a beam of coherent light directed along an optical axis. The method includes the steps of: directing a beam of light produced by at least one light-emitting diode along an optical excitation path transverse to the optical axis; geometrically confining the beam of light produced by the at least one light-emitting diode; directing the geometrically confined beam of light through an opening onto a gain medium disposed in the optical axis and the optical excitation path; and reflecting the beam of light relative to the gain medium to direct the reflected beam to produce the beam of coherent light directed along the optical axis.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIG. 1 shows a prior art schematic diagram of a tunable dye laser using a dispersive resonator and a liquid gain material/media/medium to “tune” the laser to emit light at different wavelengths.

FIG. 2 shows an example of the principle of grazing-incidence.

FIG. 3 shows a top view of a laser apparatus in accordance with the present invention for emitting a beam of coherent light directed along an optical axis.

FIG. 4 shows a side view of the light-emitting diode and the guiding member shown in FIG. 3.

FIG. 5 shows a first laser configuration employing the laser apparatus of the present invention.

FIG. 6 shows a second laser configuration employing the laser apparatus of the present invention.

FIG. 7 shows a third laser configuration employing the laser apparatus of the present invention.

FIG. 8 shows a fourth laser configuration employing the laser apparatus of the present invention.

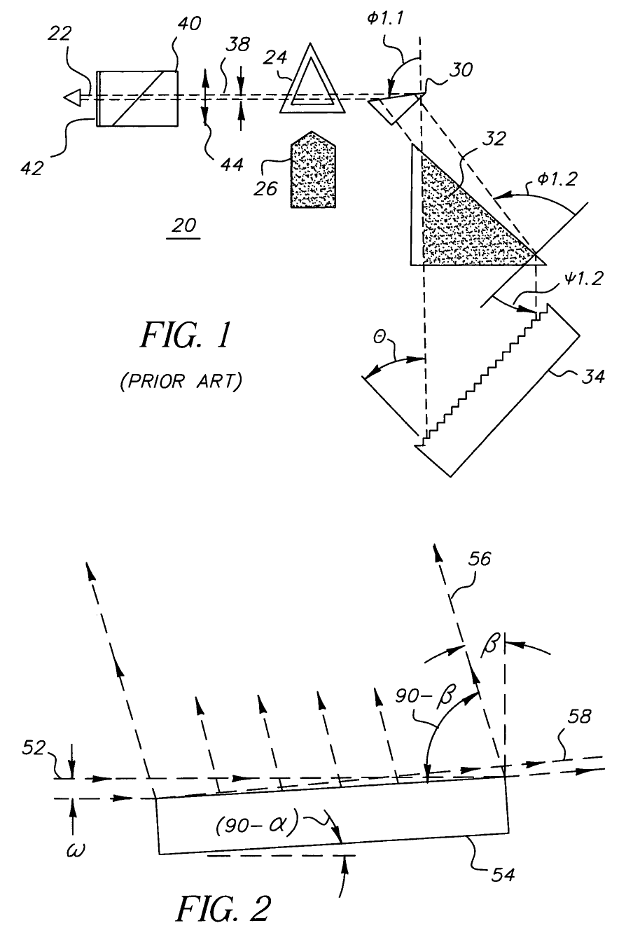

### DETAILED DESCRIPTION OF THE INVENTION

The following is a detailed description of the preferred embodiments of the invention, reference being made to the drawings in which the same reference numerals identify the same elements of structure in each of the several figures.

The present invention employs at least one light-emitting diode (LED) (preferably an LED array) to excite a gain medium/media/material. That is, in the present invention, an LED is employed to optically excite a laser gain medium to generate tunable laser emission. As will be more particularly described below, the present invention employs a waveguide configuration to replace the transverse excitation beam of conventional laser excitation, e.g., as described above with regard to commonly assigned U.S. Pat. No. 5,181,222 (Duarte), and incorporated herein by reference. In a preferred embodiment, an LED is employed to excite dye-doped polymer gain media or dye-doped Si-polymer gain media. It is noted that the present invention is applicable to other classes of solid-state lasers, for example, pure-polymer dye-doped gain media, standard crystalline gain media, and the like. However, for ease of explanation, the present invention is described with regard to dye-doped polymer and dye-doped Si-polymer gain media.

The excitation is accomplished using the principle of grazing-incidence (PGI) to obtain a spatially well-defined optical beam, preferably about 10 mm in width and about 50 μm in height. With a laser beam, such an optical beam can be obtained using standard beam shaping optics. However, with ordinary LEDs, the use of standard beam shaping optics does not yield a preferred (i.e., highly confined) spatially defined optical beam given the spatial incoherence, or high divergence, of the emission.

The present invention employs the principle of grazing-incidence (PGI); a known technique employed in applications in the field of optics. More particularly, the Frenel formulae derived from the Maxwell equations, indicates that a beam of light incident on an optical surface at a high angle of incidence is mostly reflected. For example, reflection at an angle approaching 90 degrees approaches 100%. As indicated in the book DYE LASER PRINCIPLES by Duarte, this principle is directed to diffraction gratings, which diffract at a relatively high angle of incidence.

FIG. 2 provides an example of the geometry of the principle of grazing-incidence for a beam indicated at 52 by parallel lines having a diameter indicated at W. Beam 52 is directed at an angle 90-α (degrees) onto a diffraction grating 54 and thence is diffracted at an angle β in an expanded diffracted beam (shaded area) indicated at 56 and reflected in a reflected beam as indicated at 58. At a high angle of incidence, most of the incident light is reflected at 58, even in the situation of a diffraction grating. Therefore, as explained in DYE LASER PRINCIPLES by Duarte, incorporated herein by reference, employing the PGI, a high reflection efficiency results.

Applicants employ a guiding member, such as a grazing-incidence waveguide (GIW), to guide the emission from an at least one LED to various geometries compatible with optical excitation configurations of tunable dye lasers either in the liquid or the solid state. Guiding members, including GIW, are known to those skilled in the art.

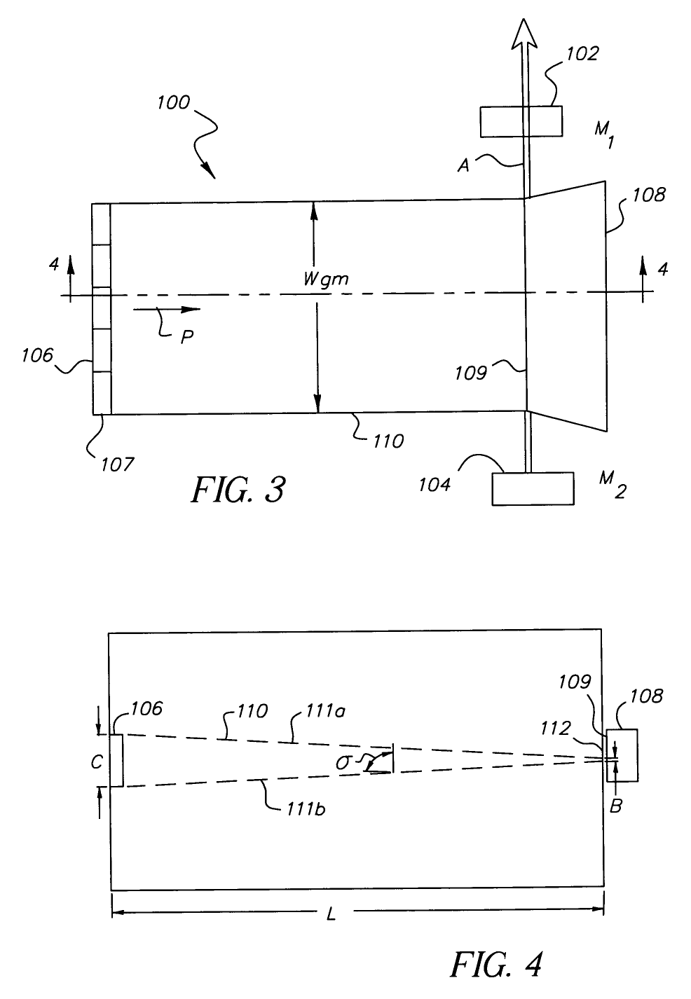

Referring now to FIG. 3, there is shown a top view of elements of a laser apparatus 100 in accordance with the present invention for emitting a beam of coherent light directed along an optical axis A. Laser apparatus 100 includes a first optical element 102 and a second optical element 104. The alignment of the first and second optical element 102,104 along the optical axis creates the optical resonator. Laser apparatus 100 also includes at least one light-emitting diode 106 (hereinafter, LED 106) producing a beam of light directed along an optical excitation path P transverse to optical axis A of laser apparatus 100. A gain medium 108 is disposed in optical axis A and optical excitation path P, intermediate first and second optical elements 102, 104, for producing the beam of coherent light along optical axis A. A guiding member 110 having a width (wgm) geometrically confines the beam of light produced by LED 106 and directs the beam of light produced by LED 106 toward gain medium 108.

In laser apparatus 100 shown in FIG. 3, guiding member 110 is disposed between light-emitting diode 106 and gain medium 108. Preferably, an array of LEDs (shown on FIG. 3 as LED array 107) is employed, and guiding member 110 is disposed between LED array 107 and gain medium 108.

As illustrated in FIG. 3, gain medium 108 has at least one substantially planar side 109, which is directed toward LED 106 and/or LED array 107.

FIG. 4 shows a side view of LED 106 and guiding member 110. As shown, LED 106 is disposed at one end of guiding member 110 and an opening/egress 112 having a height B is disposed at another end of guiding member 110, opposite LED 106, whereby guiding member 110 confines the beam of light produced by LED 106 and directs the beam of light produced by LED 106 toward opening 112 and gain medium 108. Accordingly, guiding member 110 includes at least two opposing sides 111a, 111b, which are angled at an angle σ to form opening 112 over a distance L. Guiding member 110 can be an enclosed or open member, though is preferably an enclosed member having the one opening (i.e., opening 112). If enclosed, the other side members (i.e., sides other than 111a and 111b) forming guiding member can be parallel or angled, preferably parallel.

Opening 112 is preferably adjacent gain medium 108. However, opening 112 can abut or be proximate to or spaced from gain medium 108.

In a preferred embodiment, guiding member 110 is a grazing-incidence waveguide (GIW). Further, the interior portion of guiding member 110 is preferably comprised of a reflective material. Examples of reflective materials, which are suitable for guiding member 110, include polished aluminum or an aluminum substrate covered with a high reflectivity optical coating.

In operation, LED 106 produces a beam of light directed along optical excitation path P transverse to optical axis A of laser apparatus 100. Guiding member 110 geometrically confines the beam of light produced by LED 106 and directs the beam of light produced by LED 106 toward gain medium 108. More specifically, the geometrically confined beam passes through opening 112 of guiding member 110 to form a spatially defined optical beam. The spatially defined optical beam impinges substantially planar side 109 of gain medium 108. As described above with regard to PGI, the spatially defined optical beam incident on planar side 109 (an optical surface normal to the excitation path P) is mostly absorbed by gain medium 108 whose emission is directed along optical axis A. As such, gain medium 108 absorbs most of the incident light, preferably achieving an efficiency greater than 50 percent, but an efficiency of 10-50 percent would be acceptable.

While various LEDs can be employed, examples of LEDs suitable for use in the present invention are MegaBright LEDs fabricated by CREE. In particular, CREE's CXXX-XB900-X LED, which yields 150 mW of CW (continuous wave) power at 470 nm. The particular dimensions of this particular LED are 850 μg/m×850 μm and can be packaged into approximately 2 mm×2 mm.

The dimensions of the LED shown in FIG. 4 are the dimensions of a 2 mm×2 mm LED package, which is suitable for use with the system of the present invention. A well-defined optical beam is about 5 mm to about 20 mm in width and about 50 μm to about 100 μg/m in height. A preferred embodiment is about 10 mm in width and about 50 μm in height. As such, still referring to FIG. 4, if width B is approximately 50 μm in height, and height C of LED 106 is 2 mm, then a length L of guiding member 110 is 20000 μm if σ is about 87.20 degrees.

Excitation of a particular dye-doped polymer gain medium is preferably performed by an array of LEDs which are to become the common load to a transmission line, for example five CXXX-XB900-X LEDs. The collective excitation power would then be about 750 mW. Assuming an approximate 93% conversion efficiency through guiding member 110, this power becomes approximately 700 mW.

Gain medium 108 can be comprised of a liquid or solid material. In a preferred embodiment of laser apparatus 100, gain medium 108 is a dye-doped polymer or a dye-doped Silica-polymer gain media as disclosed in U.S. Ser. No. 10/325,549, titled DYE-DOPED POLYMER NANOPARTICLE GAIN MEDIUM FOR USE IN A LASER, to inventors Duarte et al, filed on Dec. 20, 2002, commonly assigned and incorporated herein by reference. In such a configuration, the light from LED 106 is confined to a region 10 mm wide and 50 μm high. Typical laser pumping uses a beam confined to a region approximately 10 mm wide and 50 μm high. A side perspective of the waveguide is shown in FIG. 4.

With the laser apparatus of the present invention, LEDs can be employed to emit in the pulsed regime with a rise-time within 10 ns. An example calculation is now presented. LED array 107 emits a train of pulses 500 ns wide with a rise time of 10 ns. (Such an emission is a common pulsed regime in flashlamp-pumped dye lasers.)
(1) If LED array 107 emits 100 pulses per second, the energy per excitation pulse becomes 7000 μJ and the power per pulse becomes 14000 W.
(2) If LED array 107 emits 1000 pulses per second, the energy per excitation pulse becomes 700 μJ and the power per pulse becomes 1400 W.
(3) If LED array 107 emits 10000 pulses per second, the energy per excitation pulse becomes 70 μJ and the power per pulse becomes 140 W.

From this example, it is noted that laser threshold can be overcome.

The laser threshold in dye-doped polymers and dye-doped Silica-polymer gain media is about 0.01 J/cm². Accordingly, if the beam of light from LED array 107 is directed along optical excitation path P and focused to a strip 10 mm wide by 50 μm high (area of about 0.005 cm²) the energy densities (corresponding with the examples provided above) becomes:
1. ρ_{E}=1.400 J/cm²
2. ρ_{E}=0.140 J/cm²
3. ρ_{E}=0.014 J/cm²
   such that, in these cases, the laser threshold can be overcome.

With regard to conversion efficiency, using an excitation at 525 nm, the conversion efficiency for a gain medium comprising rhodamine 6G-doped MPMMA and rhodamine 6G Si-PMMA (30% silica) is about 60%. Similarly, using an excitation at 460 nm, this conversion efficiency can be expected to decrease to about 40% using the same gain medium.

Accordingly, the present invention comprises an LED-pumped laser apparatus. In a preferred embodiment, the LED-pumped laser apparatus employs a rhodamine 6G-doped MPMMA and rhodamine 6G Si-PMMA gain media. Laser operation is anticipated for a pulse repetition frequency range from a few Hz up to 10 kHz.

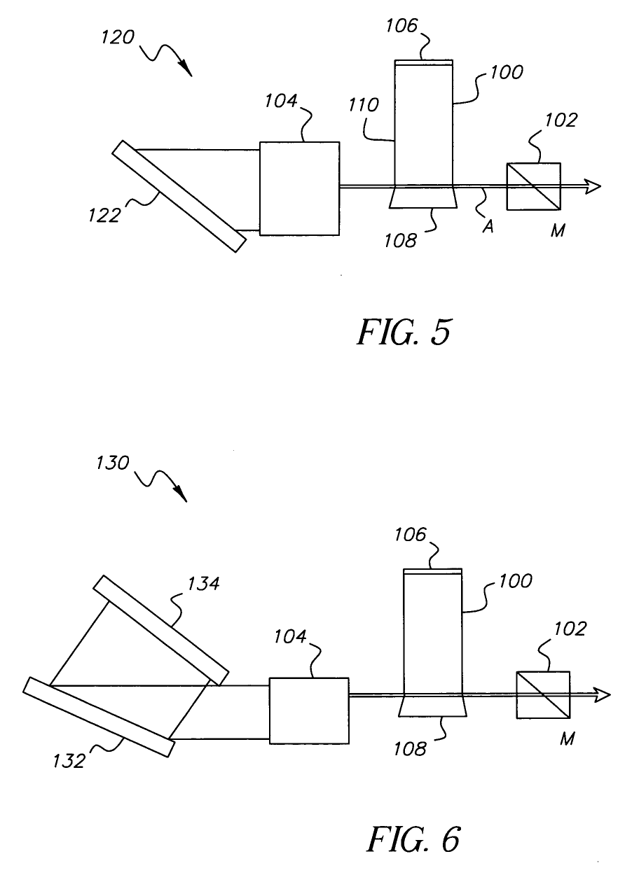

Laser apparatus 100 of the present invention can be employed in various laser configurations, as will now be described with regard to FIGS. 5-8.

FIG. 5 shows a first laser configuration 120 wherein first optical element 102 is an output-coupler polarizer comprising a reflective and non-reflective element, and second optical element 104 is a multiple-prism beam expander (MPBE). As illustrated, gain medium 108 is pumped or excited by LED array 107. In accordance with the present invention, second optical element 104 receives laser emission from gain medium 108. The emission from second optical element 104 is directed onto a grating 122, such as a diffraction grating in a Littrow mounting. After being diffracted back from the grating through second optical element 104, the light is polarized and frequency narrowed. The plane of polarization here lies parallel to the plane of FIG. 5. This polarized light passes back through gain medium 108 for further amplification and, after several passes through the gain medium, becomes a narrow linewidth laser beam. As the polarized beam continues to the right from gain medium 108, it encounters first optical element 102, which, as indicated above, is an output-coupler polarizer comprising a reflective and non-reflective member. More particularly, the outer face of the polarizer device is made partially reflecting by a suitable coating, such as a very thin layer of low-loss dielectric material, which provides reflection of a portion of the laser beam. The remaining portion of beam passes through the reflecting coating and becomes laser output beam, wherein the laser output beam is polarized in a plane parallel to the plane of FIG. 5.

FIG. 6 shows a second laser configuration 130 wherein first optical element 102 is an output-coupler polarizer comprising a reflective and non-reflective element, and second optical element 104 is a multiple-prism beam expander (MPBE). As illustrated, gain medium 108 is pumped or excited by LED array 107. In accordance with the present invention, second optical element 104 receives laser emission from gain medium 108. The emission from second optical element 104 is directed onto a grating 132 deployed in a near-grazing incidence configuration such that the light is diffracted onto a tuning mirror 134, and reflected back to grating 132 and through second optical element 104. After being transmitted back through second optical element 104, the laser light is polarized and frequency narrowed. The plane of polarization here lies parallel to the plane of FIG. 6. This polarized light passes back through gain medium 108 for further amplification and becomes a narrow linewidth laser beam. As the polarized beam continues to the right from gain medium 108, it encounters first optical element 102, which, as indicated above, is an output-coupler polarizer comprising a reflective and non-reflective member. More particularly, the outer face of the polarizer device is made partially reflecting by a suitable coating, such as a very thin layer of low-loss dielectric material, which provides reflection of a portion of the laser beam. The remaining portion of beam passes through the reflecting coating and becomes laser output beam, wherein the laser output beam is polarized in a plane parallel to the plane of FIG. 6.

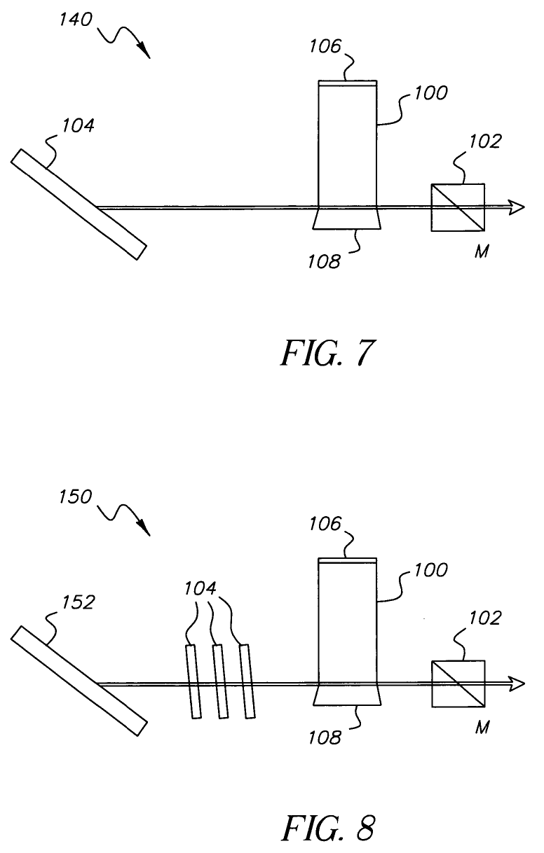

FIG. 7 shows a third laser configuration 140 wherein first optical element 102 is an output-coupler polarizer comprising a reflective and non-reflective element, and second optical element 104 is a grating deployed in a Littrow configuration. As illustrated, gain medium 108 is pumped or excited by LED array 107. In accordance with the present invention, second optical element 104 receives laser emission from gain medium 108. The emission diffracted by second optical element 104 is frequency narrowed due to the dispersion of second optical element 104, which is in a Littrow configuration. The plane of polarization here lies parallel to the plane of FIG. 7. This polarized light passes back through gain medium 108 for further amplification and becomes a narrow linewidth laser beam. As the polarized beam continues to the right from gain medium 108, it encounters first optical element 102, which, as indicated above, is an output-coupler polarizer comprising a reflective and non-reflective member. More particularly, the outer face of the polarizer device is made partially reflecting by a suitable coating, such as a very thin layer of low-loss dielectric material, which provides reflection of a portion of the laser beam. The remaining portion of the beam passes through the reflecting coating and becomes laser output beam, wherein the laser output beam is polarized in a plane parallel to the plane of FIG. 7.

FIG. 8 shows a fourth laser configuration 150 wherein first optical element 102 is an output-coupler polarizer comprising a reflective and non-reflective element, and second optical element 104 is a plurality of intracavity etalons. In addition, a grating 152 deployed in a Littrow configuration is employed. As illustrated, gain medium 108 is pumped or excited by LED array 107. In accordance with the present invention, second optical element 104 receives laser emission from gain medium 108. The light transmitted through the intracavity etalons undergoes frequency narrowing due to interference as explained in DYE LASER PRINCIPLES by Duarte. The emission from second optical element 104 is directed onto grating 152, wherein the laser light is polarized and diffracted. The plane of polarization here lies parallel to the plane of FIG. 8. This polarized light passes back through the intracavity etalons (i.e., second optical element 104) and gain medium 108 for further amplification and becomes a narrow linewidth laser beam. As the polarized beam continues to the right from gain medium 108, it encounters first optical element 102, which, as indicated above, is an output-coupler polarizer comprising a reflective and non-reflective member. More particularly, the outer face of the polarizer device is made partially reflecting by a suitable coating, such as a very thin layer of low-loss dielectric material, which provides reflection of a portion of the laser beam. The remaining portion of the beam passes through the reflecting coating and becomes laser output beam, wherein the laser output beam is polarized in a plane parallel to the plane of FIG. 7.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### Parts List

20 dye laser apparatus
22 laser output beam
24 gain medium/dye cell
26 beam
30 prism
32 second prism
34 Littrow mount grating
38 laser beam
40 polarizer device
42 coating
52 beam
54 diffracting grating
56 diffracted beam
58 reflected beam
100 Laser Apparatus
102 first optical element
104 second optical element
106 light emitting diode (LED)
107 LED array
108 gain medium
109 planar side
110 guiding member
112 opening/egress
111a opposing sides
111b opposing sides
122 grating
130 second laser configuration
132 grating
134 tuning mirror
140 third laser configuration
150 fourth laser configuration
152 second optical element

1. A laser apparatus for emitting a beam of coherent light directed along an optical axis, comprising:
a first and second optical element;
at least one light-emitting diode producing a beam of light directed along an optical excitation path transverse to the optical axis of the laser apparatus;
a gain medium disposed in the optical axis and the optical excitation path, intermediate the first and second optical elements, for producing the beam of coherent light along the optical axis; and
a guiding member for directing the beam of light produced by the at least one light-emitting diode toward the gain medium.

2. The laser apparatus according to claim 1, wherein the guiding member is disposed between the at least one light-emitting diode and the gain medium.

3. The laser apparatus according to claim 1, wherein the guiding member is comprised of a reflective material.

4. The laser apparatus according to claim 1, wherein the gain medium comprises a liquid.

5. The laser apparatus according to claim 1, wherein the gain medium comprises a solid material.

6. The laser apparatus according to claim 5, wherein the gain medium comprises a dye-doped polymer or a dye-doped Silica-polymer.

7. The laser apparatus according to claim 1, wherein the gain medium has at least one substantially planar side, and the at least one planar side is disposed toward the light-emitting diode.

8. The laser apparatus according to claim 1, wherein the gain medium has a high angle of incidence.

9. The laser apparatus according to claim 1, wherein the first or second optical element is a multiple-prism beam expander.

10. The laser apparatus according to claim 1, wherein the first or second optical element is an output-coupler polarizer.

11. The laser apparatus according to claim 1, wherein the guiding member comprises two opposing sides angled at an angle σ to form an opening disposed in the optical excitation path opposite the light-emitting diode.

12. The laser apparatus according to claim 11, wherein the opening is disposed proximate the gain medium.

13. A method for emitting a beam of coherent light directed along an optical axis, comprising the steps of:
directing a beam of light produced by at least one light-emitting diode along an optical excitation path transverse to the optical axis;
geometrically confining the beam of light produced by the at least one light-emitting diode;
directing the geometrically confined beam of light through an opening onto a gain medium disposed in the optical axis and the optical excitation path; and
reflecting the beam of light relative to the gain medium to direct the reflected beam to produce the beam of coherent light directed along the optical axis.

14. The method according to claim 13, further comprising the step of repeating the reflecting step to produce the beam of coherent light directed along the optical axis.

14. The method according to claim 13, wherein the step of reflecting is accomplished using the principle of grazing-incidence.

16. A laser apparatus for emitting a beam of coherent light comprising a light-emitting diode optically exciting a dye-doped laser gain medium.

17. The laser apparatus according to claim 16, wherein the dye-doped laser gain medium is a dye-doped polymer gain media or a dye-doped Silica-polymer gain media.
